(19) United States
(12) Patent Application Publication
(10) Pub. No.: US 2019/0140786 A1
(43) Pub. Date: May 9, 2019

(54) METHOD, SYSTEM AND APPARATUS

(71) Applicant: NOKIA SOLUTIONS AND NETWORKS OY, Espoo (FI)

(72) Inventors: Klaus Ingemann Pedersen, Aalborg (DK); Preben Elgaard Mogensen, Gistrup (DK)

(21) Appl. No.: 16/308,375

(22) PCT Filed: Jun. 10, 2016
(86) PCT No.: PCT/EP2016/063296

§ 371 Date: Dec. 10, 2018

(51) Int. Cl. H04L 1/18; H04L 1/00; H04L 5/00

(52) U.S. Cl. CPC H04L 1/1864; H04L 5/0055; H04L 1/008; H04L 1/1819

(57) ABSTRACT

A method comprising: receiving first information at a user equipment, storing at least some of the received first information at the user equipment; in response to incorrect decoding of at least some of the received first information by the user equipment, receiving second information at the user equipment, the second information comprising a hybrid automatic repeat request (HARQ) re-transmission of at least some of the first information, and the second information further comprising a scheduling allocation, the scheduling allocation comprising scheduling information of the received first information; and using the scheduling allocation, by the user equipment, to perform soft-combining of the stored first information and the received re-transmission of at least some of the first information.

### FIELD

The present invention relates to a method, apparatus and computer program and in particular but not exclusively to a method, apparatus and computer program for ultra-reliable low latency communications (URLLC) functionality.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data, machine type communications (MTC), which may have mission critical communication requirements, and so on. Non-limiting examples of services provided comprise two-way or multi-way calls, data communication or multimedia services and access to a data network system, such as the Internet.

In a wireless communication system at least a part of a communication session between at least two stations occurs over a wireless link.

Wireless communication devices can be of different types. Wireless communication devices may or may not need human interaction. A wireless communication device of a user is often referred to as user equipment (UE). Wireless communication devices that do not necessarily need human interaction for communication are sometimes referred to as machine type communication (MTC) devices. A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Another example is the long-term evolution (LTE) of the Universal Mobile Telecommunications System (UMTS) radio-access technology. LTE is being standardized by the 3rd Generation Partnership Project (3GPP). A further example is the so-called 5G or New Radio (the term used by 3GPP) networks. Standardization of 5G or New Radio networks is an on-going study item.

### SUMMARY OF INVENTION

In a first aspect there is provided a method comprising: receiving first information at a user equipment, storing at least some of the received first information at the user equipment; in response to incorrect decoding of at least some of the received first information by the user equipment, receiving second information at the user equipment, the second information comprising a hybrid automatic repeat request (HARQ) re-transmission of at least some of the first information, and the second information further comprising a scheduling allocation, the scheduling allocation comprising scheduling information of the received first information; and using the scheduling allocation, by the user equipment, to perform soft-combining of the stored first information and the received re-transmission of at least some of the first information.

According to some embodiments, the first information comprises a scheduling allocation received on a control channel and a data transmission received on a data channel.

According to some embodiments, the incorrect decoding of at least some of the received first information comprises incorrect decoding of the scheduling allocation received on the control channel.

According to some embodiments, the incorrect decoding of the scheduling allocation received on the control channel causes the user equipment to not decode the data transmission received on the data channel.

According to some embodiments, HARQ re-transmission of at least some of the first information is received in response to an absence of an ACK/NACK transmitted by the user equipment.

According to some embodiments, the soft combining comprises decoding the data transmission received on the data channel.

According to some embodiments, the scheduling allocation received in the second information is received on a control channel, the second information further comprising a data transmission received on a data channel.

According to some embodiments the soft combining comprises soft combining of the data received in the first information and the data received in the second information.

According to some embodiments, the method comprises sending an ACK message from the user equipment following decoding of the data transmission.

According to some embodiments, storing the information comprises sampling the information.

According to some embodiments, storing the information comprises storing information received on a certain set of frequency and domain resources.

According to some embodiments, the storing information received on a certain set of frequency and domain resources is independent of whether the received transmissions are intended for the user equipment.

According to some embodiments, a base station instructs the user equipment which frequency and domain resources to monitor.

According to some embodiments, if there is no specific instruction from the base station, then the user equipment is configured to monitor the full bandwidth.

According to some embodiments, the method comprises storing the information for a pre-determined length of time.

According to some embodiments, the method comprises receiving, at the user equipment, information of the pre-determined length of time.

According to some embodiments, the user equipment is configurable between a first mode in which the method is enabled and a second mode in which the method is disabled.

According to some embodiments, the method is enabled when it is detected that there is user traffic having an ultra-reliable low latency communications (URLLC) requirement.

According to some embodiments, the user equipment does not detect the stored first information until the user equipment reads the scheduling allocation in the second information.

According to a second aspect there is provided an apparatus comprising means for performing a method according to the first aspect.

According to a third aspect there is provided a computer program product for a computer, comprising software code portions for performing the steps of the first aspect when the product is run on the computer.

According to a fourth aspect there is provided a method comprising: sending first information to a user equipment; in response to a detection of incorrect decoding by the user equipment of at least some of the sent first information, sending second information to the user equipment, the second information comprising a hybrid automatic repeat request (HARQ) re-transmission of at least some of the first information, and the second information further comprising a scheduling allocation, the scheduling allocation comprising scheduling information of the sent first information.

According to some embodiments, the first information comprises a scheduling allocation sent on a control channel and a data transmission sent on a data channel.

According to some embodiments, the HARQ re-transmission of at least some of the first information is sent in response to detection of an absence of an ACK/NACK received from the user equipment.

According to some embodiments, sending the information comprises sending information on a certain set of frequency and domain resources.

According to some embodiments, the method comprises informing the user equipment of the certain set of frequency and domain resources to monitor.

According to some embodiments, the method comprises instructing the user equipment to store the information for a pre-determined length of time.

According to some embodiments, the method comprises configuring the user equipment between a first mode in which the method is enabled and a second mode in which the method is disabled.

According to some embodiments, the method is enabled when it is detected that there is user traffic having an ultra-reliable low latency communications (URLLC) requirement.

According to some embodiments, the scheduling allocation sent in the second information is sent on a control channel.

According to some embodiments, the scheduling allocation sent in the second information is sent on a control channel, the second information further comprising a data transmission sent on a data channel.

According to some embodiments, the method comprises the user equipment performing soft combining of the data sent in the first information and the data sent in the second information.

According to a fifth aspect there is provided an apparatus comprising means for performing a method according to the fourth aspect.

According to a sixth aspect there is provided a computer program product for a computer, comprising software code portions for performing the steps of any of the fourth aspect, when the product is run on the computer.

According to a seventh aspect there is provided an apparatus comprising at least one processor and at least one memory including a computer program code, the at least one memory and the computer program code configured to, with the at least one processor, cause the apparatus at least to: receive first information; store at least some of the received first information; in response to incorrect decoding of at least some of the received first information by the apparatus, receive second information at the apparatus, the second information comprising a hybrid automatic repeat request (HARQ) re-transmission of at least some of the first information, and the second information further comprising a scheduling allocation, the scheduling allocation comprising scheduling information of the received first information; and use the scheduling allocation to perform soft-combining of the stored first information and the received re-transmission of at least some of the first information.

According to some embodiments, the first information comprises a scheduling allocation received on a control channel and a data transmission received on a data channel.

According to some embodiments, the incorrect decoding of at least some of the received first information comprises incorrect decoding of the scheduling allocation received on the control channel.

According to some embodiments, the incorrect decoding of the scheduling allocation received on the control channel causes the user equipment to not decode the data transmission received on the data channel.

According to some embodiments, HARQ re-transmission of at least some of the first information is received in response to an absence of an ACK/NACK transmitted by the user equipment.

According to some embodiments, the apparatus is configured to perform the soft combining by decoding the data transmission received on the data channel

According to some embodiments, the apparatus is configured to receive the scheduling allocation received in the second information on a control channel, the second information further comprising a data transmission which the apparatus is configured to receive on a data channel.

According to some embodiments, the apparatus is configured to soft combine the data received in the first information and the data received in the second information.

According to some embodiments, the apparatus is configured to send an ACK message following decoding of the data transmission.

According to some embodiments, the apparatus is configured to store the information by sampling the information.

According to some embodiments, the apparatus is configured to store information received on a certain set of frequency and domain resources.

According to some embodiments, the storing information received on a certain set of frequency and domain resources is independent of whether the received transmissions are intended for the apparatus.

According to some embodiments, a base station instructs the apparatus which frequency and domain resources to monitor.

According to some embodiments, if there is no specific instruction from the base station, then the user equipment is configured to monitor a full bandwidth.

According to some embodiments, the apparatus is configured to store the information for a pre-determined length of time.

According to some embodiments, the apparatus is configured to receive information of the pre-determined length of time.

According to some embodiments, the apparatus is configurable between a first mode in which the method is enabled and a second mode in which the method is disabled.

According to some embodiments, the apparatus is enabled when it is detected that there is user traffic having an ultra-reliable low latency communications (URLLC) requirement.

According to some embodiments, the apparatus does not detect the stored first information until the apparatus reads the scheduling allocation in the second information.

According to an eighth aspect there is provided an apparatus comprising means for receiving first information; means for storing at least some of the received first information; in response to incorrect decoding of at least some of the received first information by the apparatus, means for receiving second information at the apparatus, the second information comprising a hybrid automatic repeat request (HARQ) re-transmission of at least some of the first information, and the second information further comprising a scheduling allocation, the scheduling allocation comprising scheduling information of the received first information; and means for using the scheduling allocation to perform soft-combining of the stored first information and the received re-transmission of at least some of the first information.

According to some embodiments, the first information comprises a scheduling allocation received on a control channel and a data transmission received on a data channel.

According to some embodiments, the incorrect decoding of at least some of the received first information comprises incorrect decoding of the scheduling allocation received on the control channel.

According to some embodiments, the incorrect decoding of the scheduling allocation received on the control channel causes the user equipment to not decode the data transmission received on the data channel.

According to some embodiments, HARQ re-transmission of at least some of the first information is received in response to an absence of an ACK/NACK transmitted by the user equipment.

According to some embodiments, the apparatus comprises means for performing the soft combining by decoding the data transmission received on the data channel

According to some embodiments, the apparatus is configured to receive the scheduling allocation received in the second information on a control channel, the second information further comprising a data transmission which the apparatus is configured to receive on a data channel.

According to some embodiments, the apparatus is configured to soft combine the data received in the first information and the data received in the second information.

According to some embodiments, the apparatus comprises means for sending an ACK message following decoding of the data transmission.

According to some embodiments, the apparatus comprises means for storing the information by sampling the information.

According to some embodiments, the apparatus comprises means for storing information received on a certain set of frequency and domain resources.

According to some embodiments, the storing information received on a certain set of frequency and domain resources is independent of whether the received transmissions are intended for the apparatus.

According to some embodiments, a base station instructs the apparatus which frequency and domain resources to monitor.

According to some embodiments, if there is no specific instruction from the base station, then the user equipment is configured to monitor a full bandwidth.

According to some embodiments, the apparatus comprises means for storing the information for a pre-determined length of time.

According to some embodiments, the apparatus comprises means for receiving information of the pre-determined length of time.

According to some embodiments, the apparatus is configurable between a first mode in which the method is enabled and a second mode in which the method is disabled.

According to some embodiments, the apparatus is enabled when it is detected that there is user traffic having an ultra-reliable low latency communications (URLLC) requirement.

According to some embodiments, the apparatus does not detect the stored first information until the apparatus reads the scheduling allocation in the second information.

In a ninth aspect there is provided an apparatus comprising at least one processor and at least one memory including a computer program code, the at least one memory and the computer program code configured to, with the at least one processor, cause the apparatus at least to: send first information to a user equipment; in response to a detection of incorrect decoding by the user equipment of at least some of the sent first information, send second information to the user equipment, the second information comprising a hybrid automatic repeat request (HARQ) re-transmission of at least some of the first information, and the second information further comprising a scheduling allocation, the scheduling allocation comprising scheduling information of the sent first information.

According to some embodiments, the first information comprises a scheduling allocation sent on a control channel and a data transmission sent on a data channel.

According to some embodiments, the HARQ re-transmission of at least some of the first information is sent in response to detection of an absence of an ACK/NACK received from the user equipment.

According to some embodiments, sending the information comprises sending information on a certain set of frequency and domain resources.

According to some embodiments, the apparatus is configured to inform the user equipment of the certain set of frequency and domain resources to monitor.

According to some embodiments, the apparatus is configured to instruct the user equipment to store the information for a pre-determined length of time.

According to some embodiments, the apparatus is configured to configure the user equipment between a first mode in which the method is enabled and a second mode in which the method is disabled.

According to some embodiments, the apparatus is configured to operate as set-out above when it is detected that there is user traffic having an ultra-reliable low latency communications (URLLC) requirement.

According to some embodiments, the apparatus is configured to send the scheduling allocation sent in the second information on a control channel.

According to some embodiments, the apparatus is configured to send the scheduling allocation sent in the second information on a control channel, the second information further comprising a data transmission sent on a data channel.

According to some embodiments, the method comprises the user equipment performing soft combining of the data sent in the first information and the data sent in the second information.

In a tenth aspect there is provided an apparatus comprising means for sending first information to a user equipment; in response to a detection of incorrect decoding by the user equipment of at least some of the sent first information, means for sending second information to the user equipment, the second information comprising a hybrid automatic repeat request (HARQ) re-transmission of at least some of the first information, and the second information further comprising a scheduling allocation, the scheduling allocation comprising scheduling information of the sent first information.

According to some embodiments, the first information comprises a scheduling allocation sent on a control channel and a data transmission sent on a data channel.

According to some embodiments, the HARQ re-transmission of at least some of the first information is sent in response to detection of an absence of an ACK/NACK received from the user equipment.

According to some embodiments, sending the information comprises sending information on a certain set of frequency and domain resources.

According to some embodiments, the apparatus comprises means for informing the user equipment of the certain set of frequency and domain resources to monitor.

According to some embodiments, the apparatus comprises means for instructing the user equipment to store the information for a pre-determined length of time.

According to some embodiments, the apparatus comprises means for configuring the user equipment between a first mode in which the method is enabled and a second mode in which the method is disabled.

According to some embodiments, the apparatus is configured to operate as set-out above when it is detected that there is user traffic having an ultra-reliable low latency communications (URLLC) requirement.

According to some embodiments, the apparatus comprises means for sending the scheduling allocation sent in the second information on a control channel.

According to some embodiments, the apparatus comprises means for sending the scheduling allocation sent in the second information on a control channel, the second information further comprising a data transmission sent on a data channel.

According to some embodiments, the apparatus comprises means for performing soft combining of the data sent in the first information and the data sent in the second information.

### BRIEF DESCRIPTION OF FIGURES

FIG. 1 shows a schematic diagram of an example communication system comprising a plurality of base stations and a plurality of communication devices;

FIG. 2 shows a schematic diagram of an example mobile communication device;

FIG. 3 shows a schematic diagram of an example control apparatus;

FIG. 4 shows a signaling diagram according to an embodiment;

FIG. 5 shows a flow chart of a method according to an embodiment;

FIG. 6 shows a flow chart of a method according to an embodiment.

### DETAILED DESCRIPTION

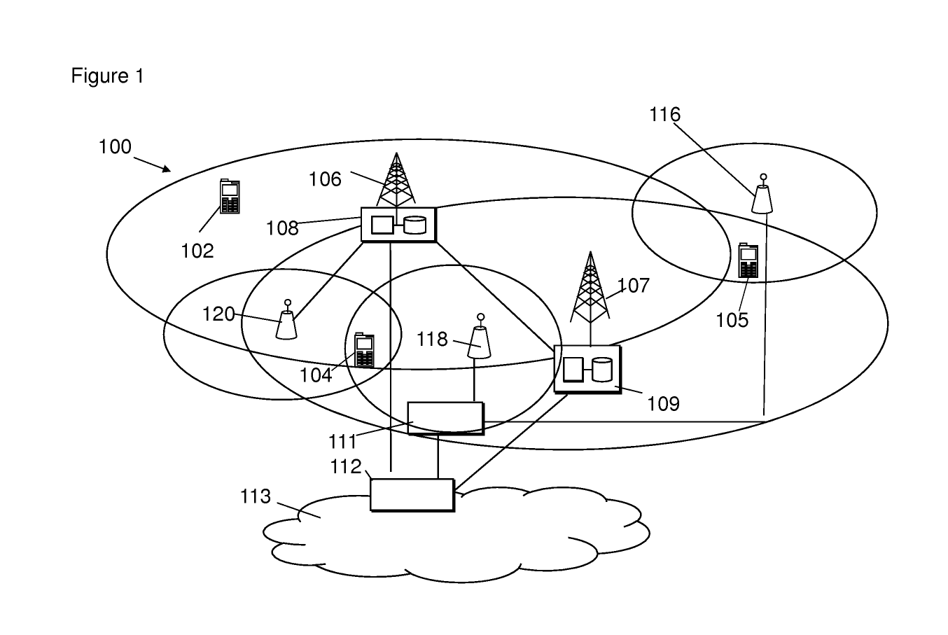

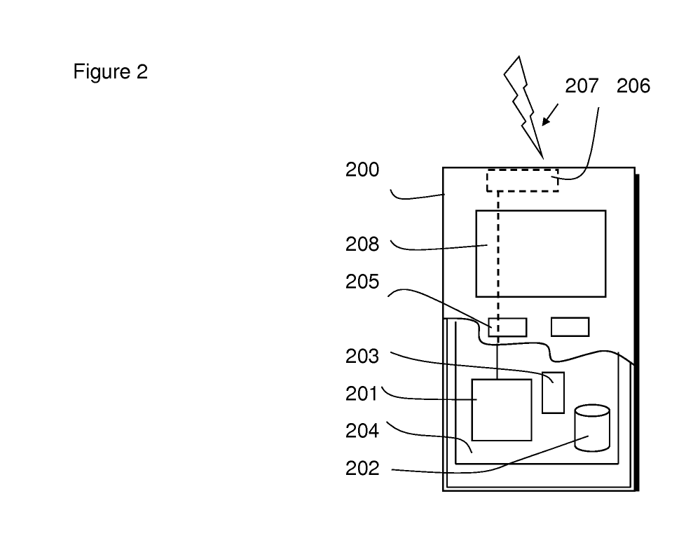

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, a wireless communication devices, for example, user equipment (UE) or MTC devices 102, 104, 105 are provided wireless access via at least one base station or similar wireless transmitting and/or receiving wireless infrastructure node or point. Such a node can be, for example, a base station or an eNodeB (eNB), or other wireless infrastructure node. These nodes will be generally referred to as base stations. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller. Other examples of radio access system comprise those provided by base stations of systems that are based on technologies such as 5G or new radio, wireless local area network (WLAN) and/or WiMax (Worldwide Interoperability for Microwave Access). A base station can provide coverage for an entire cell or similar radio service area.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible wireless communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the wireless device.

A wireless device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the wireless device by means of a suitable user interface such as key pad 205, voice commands, touch sensitive screen or pad, combinations thereof or the like. A display 208, a speaker and a microphone can be also provided. Furthermore, a wireless communication device may comprise appropriate connectors (either wired or wireless) to other devices and/or for connecting external accessories, for example hands-free equipment, thereto. The communication devices 102, 104, 105 may access the communication system based on various access techniques.

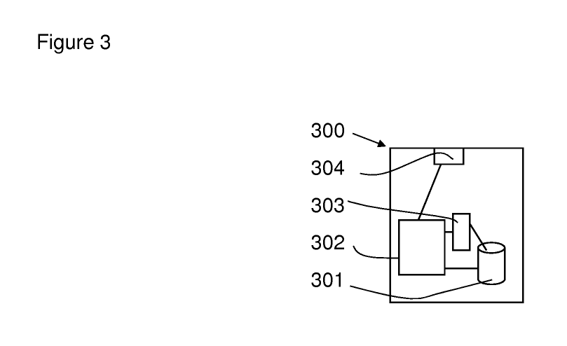

FIG. 3 shows an example of a control apparatus for a communication system, for example to be coupled to and/or for controlling a station of an access system, such as a RAN node, e.g. a base station, (e) node B, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions.

Embodiments are related to 5G concept design, and propose a new HARQ operation mode that is optimized for ultra-reliable low latency communications (URLLC). URLLC is one of the most challenging use cases for the ongoing standardization of a 5G new radio in 3GPP [3GPP TR 38.913].

URLLC environments may include, for example, wireless automation, such as remote robotics, surgery, tactile internet etc. Therefore URLLC may demand an end-to-end latency of a few milliseconds.

In a known scheduled system the base station (eNB) sends a scheduling allocation to a user equipment (UE), followed by the actual data transmission. The scheduling allocation is sent to the UE on a dedicated physical-layer control channel (CCH), while the data transmission is sent on a physical-layer data channel (DCH), which may be a physical layer shared data channel (PDSCH). In addition to notifying the UE of the data transmission, the CCH may also include information such as the modulation and coding scheme that is being used, radio resources for the data transmission, Hybrid ARQ (HARQ) info, MIMO info, etc. Only if the UE successfully decodes the CCH does it attempt decoding of the data channel transmission. If the UE fails in correctly decoding the data channel transmission, it feeds back a negative acknowledgement (NACK), and waits for a subsequent HARQ retransmission. When the HARQ retransmission arrives (assuming the UE correctly decodes the scheduling allocation on the CCH), HARQ soft combining is performed, thereby improving the probability of successful decoding.

However, it cannot be guaranteed that the UE always correctly decodes the CCH. There will always be a probability (which may be a small probability) of erroneous decoding of the CCH. If the UE fails to decode the CCH, the UE will miss the data channel transmissions as well. Therefore when the eNB makes a second attempt to transmit the data to the UE, there is no HARQ combining gain, and hence a higher error probability as compared to the case where the HARQ combining gain is intact. For mobile broad band services, these error scenarios may be of marginal importance, but they may become an obstacle for fulfilling URLLC requirements.

According to some embodiments, a user equipment is configured to sample and store information received from a base station. If the base station does not receive an ACK/NACK reply, then it assumes that the earlier sent information has not been properly decoded. Accordingly the base station begins HARQ retransmission of the earlier sent data. As part of the HARQ retransmission the base station transmits a scheduling allocation which refers to the earlier sent information. This scheduling allocation can be used by the UE to perform soft combining of the data from the first transmission and the HARQ retransmission. This improves latency of the system.

Therefore some embodiments preserve the HARQ combining gain for a second transmission of the same payload, even if the user equipment has failed to decode the CCH with scheduling allocation from the first transmission. This is explained in further detail below.

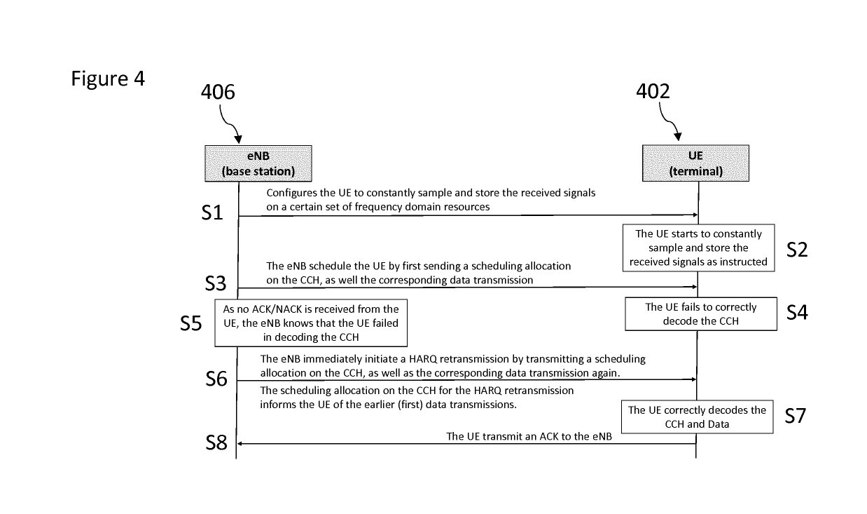

A method according to an embodiment is shown in more detail with respect to FIG. 4. FIG. 4 shows a base station (eNB) 406 in communication with a UE or terminal 402.

At step S1 the base station 406 configures the UE 402 to sample and store received signals from the base station. In some embodiments this may be a constant sampling of stored and received signals. These may be signals on a certain set of frequency domain resources. In some embodiments the base station also informs the UE 402 of the set of frequency domain resources to monitor. In some embodiments the saving of information by a UE may be performed independently of whether that information is intended for that UE.

Then, at step S2 the UE 402 starts to sample and store the received signals as instructed. In some embodiments this may be a constant sampling. In some embodiments, the base station also informs the UE for how long to save received samples. In some embodiments this instruction (how long to save received samples) may be received as part of step S1, when the base station 406 configures the UE 402 to sample and store received signals. Accordingly it may be considered that the UE is configured to save or store the received information for a predetermined amount of time.

At step S3 the eNB 406 begins sending information to the UE 402. For the purposes of explanation this information may be considered “first” information. This first information may comprise a scheduling allocation sent on a control channel CCH, as well as the corresponding data transmission on a data channel (e.g. PDSCH).

As shown at step S4, in this example the UE 402 fails to correctly decode the CCH. Accordingly, as explained above the UE 402 will also fail to decode the data on the data channel. As a result of this, the UE 402 is effectively unaware of the data it has received, and accordingly does not send an ACK/NACK to the eNB 406.

As shown at step S5, since no ACK/NACK is received from the UE 402, the eNB 406 determines that the UE 402 has failed in decoding the CCH.

As shown at step S6, in response to the absence of a received ACK/NACK at the eNB, the eNB 406 initiates a HARQ retransmission to the UE 406. For the purposes of explanation the HARQ retransmission may be considered a “second” transmission. The HARQ retransmission comprises a scheduling allocation on the CCH, as well as the corresponding data transmission again. The scheduling allocation on the CCH from the HARQ retransmission informs the UE 402 of the earlier (first) data transmission. The information that informs the UE 402 of the first transmission may include the information that was sent on the CCH for the first transmission. For example the information sent on the control channel in the HARQ retransmission (and indeed in the first transmission) may include information on the resources (PRBs) for the first transmission, the used modulation and coding scheme, as well as potential MIMO information. Therefore all the information that the UE missed because it failed to decode the first CCH transmission, may be included on the CCH in the HARQ retransmission.

Then, as shown at step S7 the UE 402 can correctly decode the control channel and data received in the HARQ retransmission. This may comprise soft combining with the information already sampled and stored in the first transmission. Then, as shown at step S8 the UE 402 transmits an ACK to the eNB 406 to confirm that the information has been correctly received and decoded.

In some embodiments, steps S5 and S6 can be replaced by the eNB blindly retransmitting the transmission until it receives an ACK from the UE. This approach may help reduce the latency, but increases the use of transmission resources as some retransmissions may not be needed.

For the purposes of explanation and by way of example only, an error probability for decoding of the CCH and Data CH equals P_{A} and P_{B}, respectively, for a first transmission. An error probability P₁ of correctly receiving the first data transmission may therefore be considered to be P₁=P_{A}+(1−P_{A}) P_{B}. If the UE fails to correctly decode the CCH (scheduling allocation) for the first transmission, an error probability P₂ for second transmission (i.e. the first HARQ transmission) is P₁=P₂ for normal HARQ operation. If the UE correctly decodes the CCH from the first transmission (but fails to correctly decode the Data CH), then P₂=P_{A}+(1−P_{A}) P′_{B}, where P′_{B} is an error probability for decoding of the Data CH when including the HARQ combining gain.

However, in some embodiments and by way of example only, P₂=P_{A}+(1−P_{A}) P′_{B}. For cases where P_{B}≤1e−2, it may be considered that effectively P′_{B}=0, meaning that in some embodiments P₂=P_{A}. With the proposal, the error probability for 2^{nd} transmissions (i.e. first HARQ retransmission) may be significantly reduced, as compared to normal HARQ operation. The probability P of not having correctly received the data transmission after the second transmission is, according to some embodiments, P=P₁P₂. Hence, by way of example, for P_{A}=1e−3 and P_{B}=1e−2 we have P=1.1e−5 in some embodiments, meaning that the 3GPP defined reliability target for URLLC may be fulfilled.

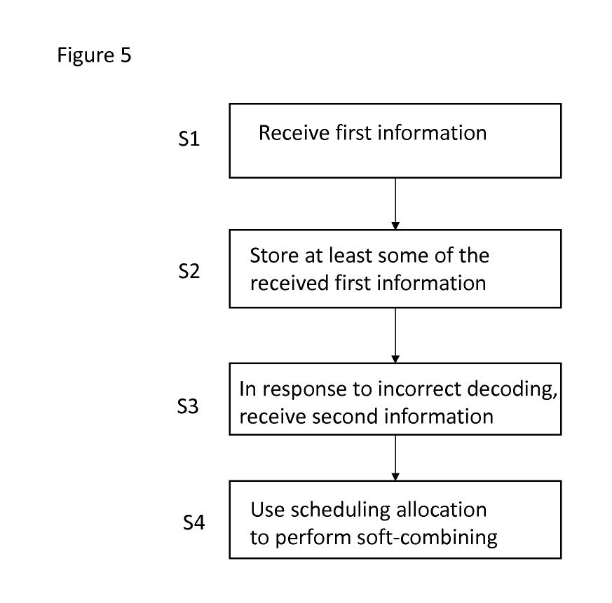

FIG. 5 is a flow chart of a method, according to an example viewed from the perspective of a user equipment.

At step S1, the user equipment receives first information. This information may include control information on a CCH, and data on a DCH.

At step S2, at least some of the received information is stored at the user equipment.

At step S3, in response to incorrect decoding of at least some of the received first information by the user equipment, second information is received at the user equipment. The second information comprises a hybrid automatic repeat request (HARQ) re-transmission of at least some of the first information, and the second information further comprises a scheduling allocation, the scheduling allocation comprising scheduling information of the received first information.

At step S4, the user equipment uses the scheduling allocation to perform soft-combining of the stored first information and the received re-transmission of at least some of the first information.

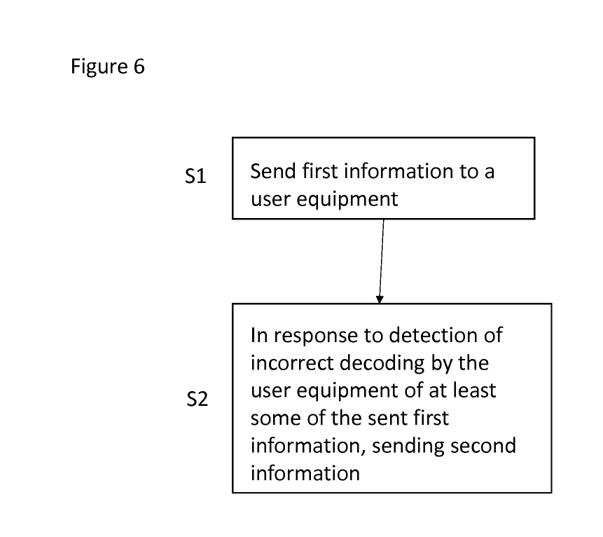

FIG. 6 is a flow chart of a method, according to an example viewed from the perspective of an eNB.

At step S1, the eNB sends first information to a user equipment. The first information may comprise control information sent on a control channel, and data sent on a data channel.

At step S2, in response to a detection of incorrect decoding by the user equipment of at least some of the sent first information, the method comprises sending second information to the user equipment. The second information comprises a hybrid automatic repeat request (HARQ) re-transmission of at least some of the first information, and the second information further comprises a scheduling allocation, the scheduling allocation comprising scheduling information of the sent first information.

As mentioned earlier, a “cost” may be considered that the UE has to store received signal samples from part of the carrier bandwidth (for example at baseband level). This requires additional memory and UE energy consumption. However, these “costs” may be considered justified by the benefits of the embodiments for URLLC use cases. For example the proposed procedure may make performance less sensitive to CCH decoding errors, which is otherwise particularly challenging for URLLC. As the proposal may have marginal benefits for MBB (mobile broadband) use cases, in embodiments the network may be able to selectively activate the proposed method only for UEs with URLLC.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
receiving first information at a user equipment,
storing at least some of the received first information at the user equipment;
in response to incorrect decoding of at least some of the received first information by the user equipment, receiving second information at the user equipment, the second information comprising a hybrid automatic repeat request (HARQ) re-transmission of at least some of the first information, and the second information further comprising a scheduling allocation, the scheduling allocation comprising scheduling information of the received first information; and
using the scheduling allocation, by the user equipment, to perform soft-combining of the stored first information and the received re-transmission of at least some of the first information.

2. A method as set forth in claim 1, wherein the first information comprises a scheduling allocation received on a control channel and a data transmission received on a data channel.

3. A method as set forth in claim 2, wherein the incorrect decoding of at least some of the received first information comprises incorrect decoding of the scheduling allocation received on the control channel.

4. A method as set forth in claim 1, wherein the HARQ re-transmission of at least some of the first information is received in response to an absence of an ACK/NACK transmitted by the user equipment.

5. A method as set forth in claim 1, wherein the soft combining comprises decoding the data transmission received on the data channel.

6. A method as set forth in claim 1, wherein storing the information comprises storing information received on a certain set of frequency and domain resources.

7. A method as set forth in claim 1, wherein the method comprises storing the information for a pre-determined length of time.

8. A method as set forth in claim 1, wherein the user equipment is configurable between a first mode in which the method is enabled and a second mode in which the method is disabled.

9. A method as set forth in claim 8, wherein the method is enabled when it is detected that there is user traffic having an ultra-reliable low latency communications (URLLC) requirement.

10. A method comprising:
sending first information to a user equipment;
in response to a detection of incorrect decoding by the user equipment of at least some of the sent first information, sending second information to the user equipment, the second information comprising a hybrid automatic repeat request (HARQ) re-transmission of at least some of the first information, and the second information further comprising a scheduling allocation, the scheduling allocation comprising scheduling information of the sent first information.

11. A method as set forth in claim 10, wherein the first information comprises a scheduling allocation sent on a control channel and a data transmission sent on a data channel.

12. A method as set forth in claim 10, wherein the HARQ re-transmission of at least some of the first information is sent in response to detection of an absence of an ACK/NACK received from the user equipment.

13. A method as set forth in claim 10, wherein sending the information comprises sending information on a certain set of frequency and domain resources.

14. A method as set forth in claim 10, wherein the method comprises instructing the user equipment to store the information for a pre-determined length of time.

15. A method as set forth in claim 10, comprising configuring the user equipment between a first mode in which the method is enabled and a second mode in which the method is disabled.

16. A method as set forth in claim 10, wherein the method is enabled when it is detected that there is user traffic having an ultra-reliable low latency communications (URLLC) requirement.

17. A method as set forth in claim 10, wherein the scheduling allocation sent in the second information is sent on a control channel.

18. (canceled)

19. A non-transitory computer-readable storage medium storing instructions that when executed cause a processor to perform the steps of claim 1.

20. An apparatus comprising:
at least one processor and at least one memory including a computer program code, the at least one memory and the computer program code configured to, with the at least one processor, cause the apparatus at least to:
receive first information;
store at least some of the received first information;
in response to incorrect decoding of at least some of the received first information by the apparatus, receive second information at the apparatus, the second information comprising a hybrid automatic repeat request (HARQ) re-transmission of at least some of the first information, and the second information further comprising a scheduling allocation, the scheduling allocation comprising scheduling information of the received first information; and
use the scheduling allocation to perform soft-combining of the stored first information and the received re-transmission of at least some of the first information.

21-30. (canceled)

31. A non-transitory computer-readable storage medium storing instructions that when executed cause a processor to perform the steps of claim 10.
